(19) United States
(12) Patent Application Publication
(10) Pub. No.: US 2005/0243393 A1
(43) Pub. Date: Nov. 3, 2005

(54) Light scanning unit and image forming apparatus using the same

(75) Inventor: Chul-hyun Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/052,884

(22) Filed: Feb. 9, 2005

(30) Foreign Application Priority Data
Apr. 28, 2004 (KR) 10-2004-0029672

(51) Int. Cl. G02B 26/08; G02F 1/03; G02F 1/07

(52) U.S. Cl. 359/206; 359/259

(57) ABSTRACT

A light scanning unit and an image forming apparatus adopting the same substantially prevent diffused reflection from a polygonal mirror and contamination of the polygonal mirror. The light scanning unit includes a light source for generating light. A beam deflector deflects and scans the light from the light source in a primary scanning direction of an object. A housing encloses the light source and the beam deflector. A cap member preferably integrally formed with the housing encloses a periphery of the beam deflector.

### BACKGROUND OF THE INVENTION

This application claims the benefit under 35 U.S.C. § 119(a) of Korean Patent Application No. 10-2004-0029672 filed on Apr. 28, 2004, in the Korean Intellectual Property Office, the entire disclosure of which is hereby incorporated by reference.

### FIELD OF THE INVENTION

The present invention relates to a light scanning unit for scanning light from a light source over an object, and an image forming apparatus adopting the same. More particularly, the present invention relates to a light scanning unit and an image forming apparatus adopting the same that substantially prevent diffused reflection from a polygonal mirror and contamination of the polygonal mirror.

### DESCRIPTION OF THE RELATED ART

Generally, light scanning units are used in apparatuses such as laser printers, digital copying machines, bar-code readers, and facsimiles, to form a latent image on an object through a primary scanning by a beam deflector and a secondary scanning by movement of the object.

Referring to FIG. 1, the general light scanning unit includes a light source 1 for generating light, a beam deflector 7 for deflecting incident light so that a beam emitted from the light source 1 may illuminate an object 15, and an f-θ lens 11 for correcting errors in the beam deflected by the beam deflector 7. Additionally, a collimating lens 3 for condensing diverged light from the light source 1, and a cylindrical lens 5 for aligning light, may be provided in the optical path between the light source 1 and the beam deflector 7. A reflection mirror 13 for changing the direction of scanned light may be provided between the f-θ lens 11 and the object 15.

The beam deflector 7 includes a driving source 9 and a polygonal mirror 8 rotated by the driving source 9. Accordingly, the rotation of the polygonal mirror 8 changes the direction of the beam from the light source 1, thereby determining its scanning direction. Therefore, as the polygonal mirror 8 rotates, the beam incident on the polygonal mirror 8 scans the photosensitive medium 15 in the direction indicated by arrow A.

A light scanning unit having such construction is very sensitive to contamination. The polygonal mirror 8 must be kept perfectly clean, otherwise light scanning performance will suffer. Therefore, such contamination needs to be prevented.

Regarding this matter, Japanese laid-open patent publication No. H 5-72495 titled ‘Laser Beam Printer’ and open to the public as of Mar. 26, 1993, discloses a cover for preventing contamination of the polygonal mirror. The disclosed cover, which is provided separately from the optical box including the light scanning unit, is provided inside the optical box so that it covers the polygonal mirror. The cover has a groove in one side sealed with glass, through which a beam passes. Such a cover can prevent the surface of the polygon mirror from being contaminated during operation.

However, since the above construction requires a separate cover for preventing contamination of the polygonal mirror, the additional parts increase the manufacturing costs and complicate assembly and production processes.

### SUMMARY OF THE INVENTION

The present invention provides a light scanning unit having an improved construction and an image forming apparatus adopting the same to substantially prevent contamination of a polygonal mirror and diffused reflection by the polygon mirror without requiring additional elements.

According to an aspect of the present invention, a light scanning unit includes a light source for generating light, a beam deflector for deflecting and scanning the light from the light source in a primary scanning direction of an object, a housing for enclosing the light source and the beam deflector, and a cap member integrally formed with the housing for enclosing the periphery of the beam deflector.

According to another aspect of the present invention, an image forming apparatus includes a developing unit having a toner container for accommodating toner of a predetermined color and an image forming part that is supplied with toner from the toner container to help form an image. A light scanning unit scans light on the image forming part to form an electrostatic latent image, and has a light source to generate light. A beam deflector deflects and scans the light from the light source in a primary scanning direction of an object. A housing encloses the light source and the beam deflector. A cap member is preferably integrally formed with the housing to enclose the periphery of the beam deflector. A transfer unit corresponds the image forming part to transfer an image formed by the image forming part to a printing medium. A fusing unit fixes an image transferred to the printing medium.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of the optical arrangement of a conventional light scanning unit;

FIG. 2 is an exploded perspective view of a light scanning unit according to an embodiment of the present invention;

FIG. 3 is a cross-sectional, elevational view of the light scanning unit of FIG. 2 in a separated condition;

FIG. 4 is a cross-sectional, elevational view of the light scanning unit of FIG. 2 in an assembled condition;

FIG. 5 is an exploded perspective view of a light scanning unit according to another embodiment of the present invention; and

FIG. 6 is a cross-sectional diagram of an image forming apparatus according to an embodiment of the present invention.

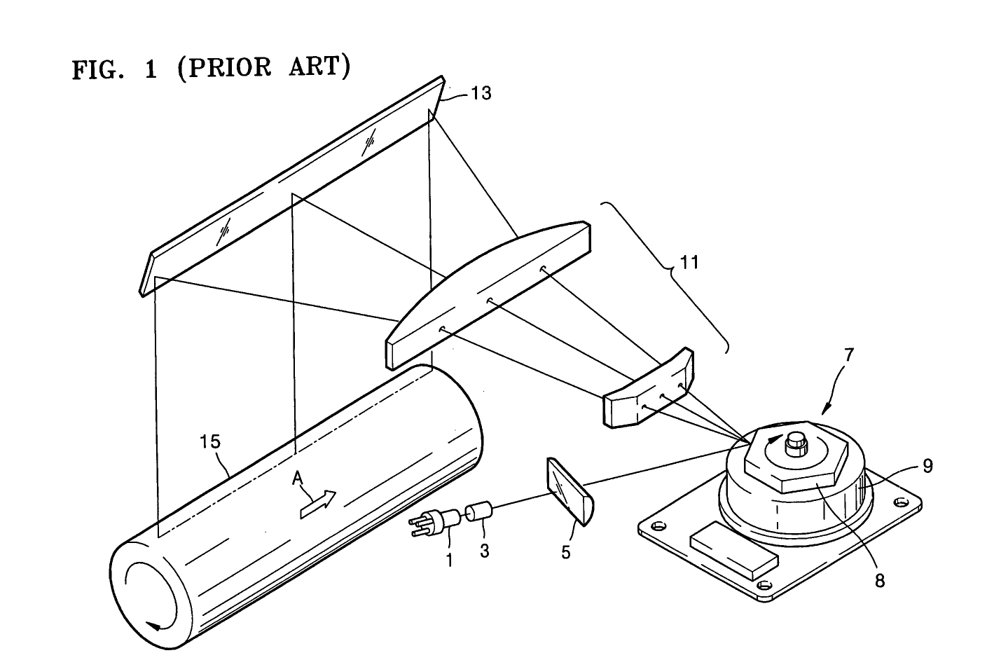

Throughout the drawings, like reference numerals will be understood to refer to like parts, components and structures.

### DETAILED DESCRIPTION OF EXEMPLARY EMBODIMENTS

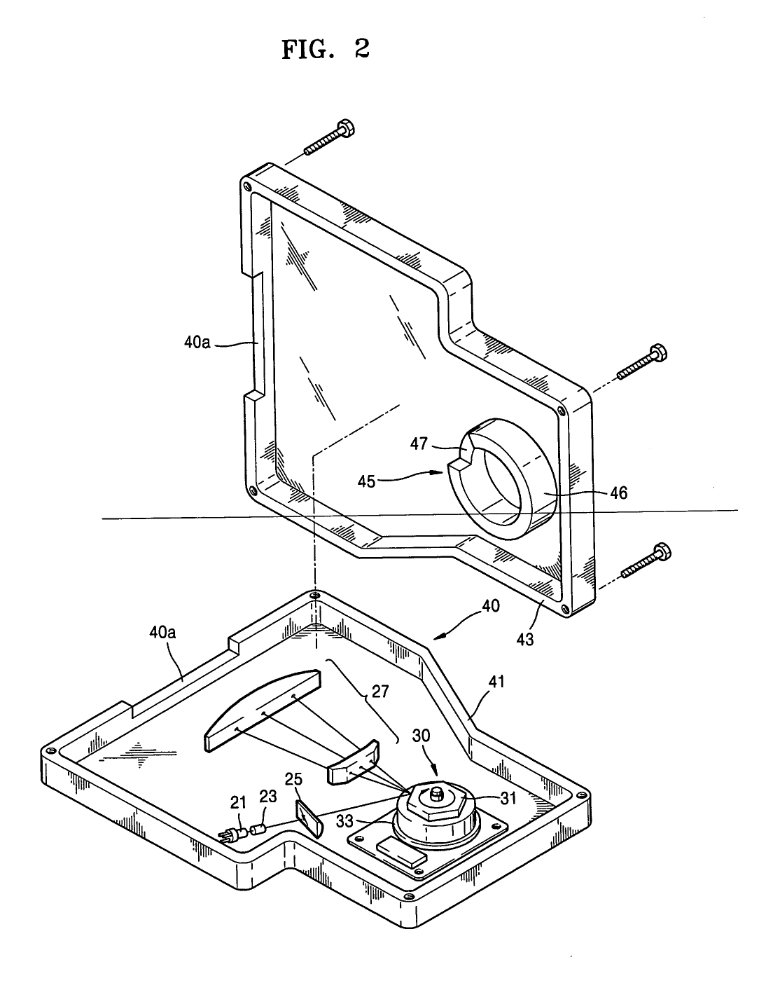

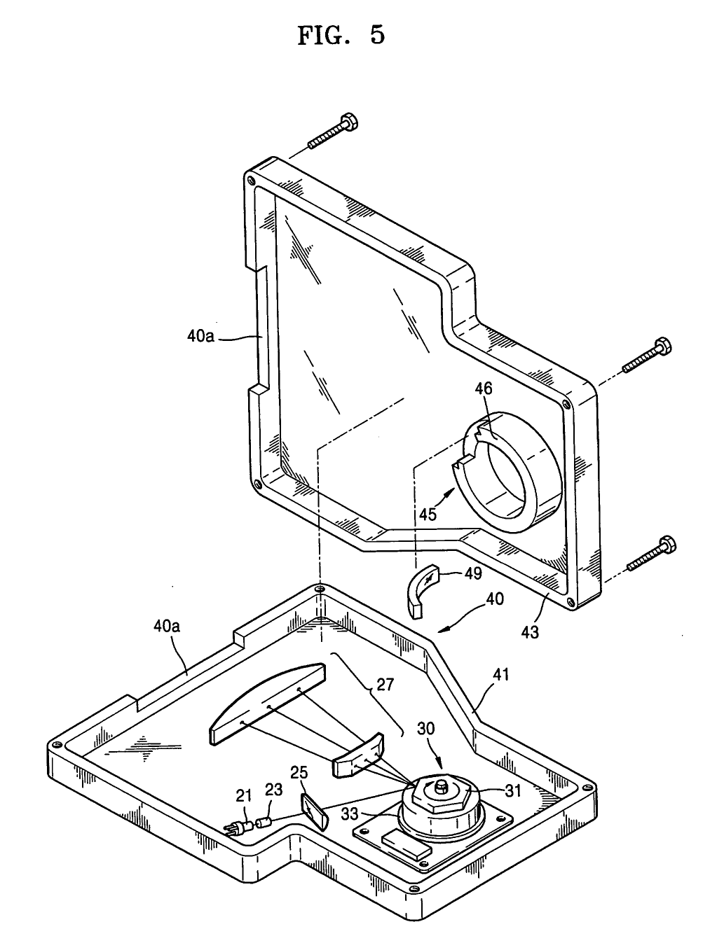

Referring to FIGS. 2 through 4, a light scanning unit according to an embodiment of the present invention includes a light source 21 and a beam deflector 30 for deflecting and scanning the light illuminated from the light source 21. A housing 40 encloses the light source 21 and the beam deflector 30. A cap member 45 is preferably integrally formed with the housing 40.

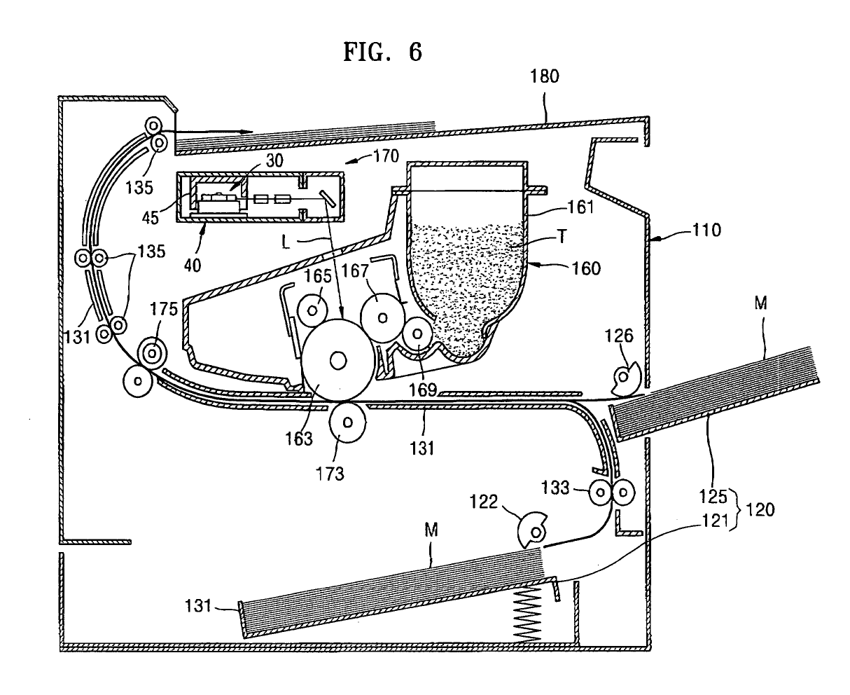

The light source 21 is modulated in such a way that light selectively illuminates an object, for example, a portion of a photosensitive medium 163 (FIG. 6) where a latent image will be formed. The light source 21 includes a semiconductor laser or an LED (Light Emitting Diode). Here, since the construction of the light source 21 is well known to those skilled in the art, a detailed description thereof is omitted.

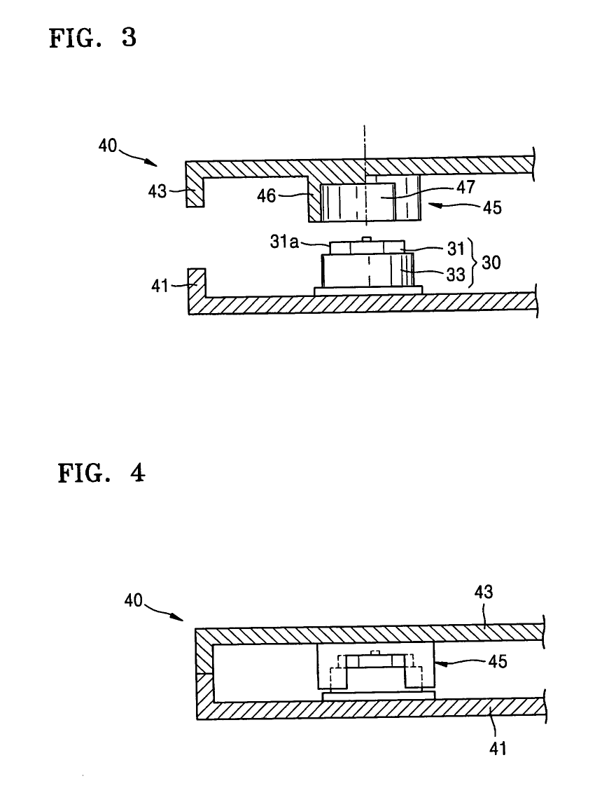

The beam deflector 30, which deflects and scans the light from the light source 21 in a primary scanning direction of an object, includes a driving source 33 and a polygonal mirror 31 installed in a rotatable manner with respect to the driving source 33. The polygonal mirror 31 includes a plurality of reflection planes 31a(FIG. 3) formed on its sides and to deflect and scan incident light while rotating.

The housing 40, which includes a base 41 and a cover member 43 for covering the base 41, encloses the light source 21 and the beam deflector 30 so that the light scanning unit forms a single unit.

The light source 21 and the beam deflector 30 are installed inside the housing 40. In the meantime, a predetermined position 40a on one side of the housing 40, that is, the output path of the scanned beam, is open. Therefore, light deflected and scanned from the beam deflector 30 may be directed outside of the housing 40 through the open position (opening) 40a.

The cap member 45 is preferably integrally formed with the inside of the housing 40, that is, on the inside of the cover member 43, to substantially prevent contamination of the beam deflector 30 and diffused reflection by the reflection plane 31a. The cap member 45 includes a cap 46 having a space for receiving the beam deflector 30 and an opening 47 in part of the cap 46.

The cap 46 projects outwardly from an inner surface of the cover member 45, and encloses the polygonal mirror 31 to substantially prevent the ingress of contaminants from the outside, thereby keeping the polygonal mirror 31 clean. Additionally, diffused reflection is substantially prevented by preventing light scanned from the polygon mirror 31 from reflecting off other optical elements and returning to the polygonal mirror 31. The cap 46 may have a polygonal structure, such as a hexagon, a circle or any other suitable polygonal shape, as shown in the drawing.

The opening 47 is formed on the cap 46 to allow light from the light source 21 and light scanned from the beam deflector 30 to pass in and out. The cap 46 reduces the amount of contaminants that reach the polygonal mirror through that opening 47 than when the cap 46 is not provided. Additionally, the opening 47 in the cap 46 is not substantially subjected to contamination.

Also, preferably, the light scanning unit according to an embodiment of the present invention additionally includes an f-θ lens 27 arranged on the optical path between the beam, deflector 30 and an object. This f-θ lens 27 focuses light onto an object by correcting the light deflected from the beam deflector 30 with different magnifications with respect to a primary and a secondary scanning direction. Here, the secondary direction is a moving direction of an object and the primary direction is an axial direction of an object, namely, the direction in which the beam is deflected by the beam deflector 30.

Preferably, the light scanning unit has a collimating lens 23 and at least one cylindrical lens 25 on the optical path between the light source 21 and the beam deflector 30. The collimating lens 23 condenses the beam emitted from the light source 21 into a parallel beam or a converging beam. The cylindrical lens 25 concentrates differently incident light in the primary and the secondary scanning directions so that the incident light may be focused onto the beam deflector 30.

Referring to FIG. 5, the light scanning unit according to another embodiment of the present invention includes a light source 21, a beam deflector 30 for deflecting and scanning the light from the light source 21, a housing 40 enclosing the light source 21 and the beam deflector 30, and a cap member 45 preferably integrally formed with the housing 40. Here, since the light source 21, the beam deflector 30, and the housing 40 are substantially the same as previously described, a repeat description thereof is omitted.

The cap member 45 includes a cap 46 having a space for receiving the beam deflector 30, an opening 47 in part of the cap 46, and a cover glass 49 disposed in the opening 47 to transmit incident light. The cover glass 49, together with the cap 46 as mentioned above, further prevents contaminants from reaching the polygonal mirror 31 from the outside.

Referring to FIG. 6, an image forming apparatus according to an embodiment of the present invention includes a cabinet 110 and a developing unit 160 mounted inside the cabinet 110. A light scanning unit 170 forms an electrostatic latent image, and a transfer unit 173 transfers an image formed by the developing unit 160. A fusing unit 175 fuses the image transferred to a printing medium.

The cabinet 110, which defines the external appearance of the image forming apparatus, has a discharging unit 180 in which is loaded a discharged printing medium M. Also, a supplying unit 120 in which a printing medium M to be supplied is loaded is detachably connected to the cabinet 110. The printing medium M supplied by the supplying unit 120 is transferred in the direction of the developing unit 160 through a transferring path 131.

The supplying unit 120 includes a first supply part 121 for automatic supply of the printing medium M and a second supply part 125 for manual supply. The first supply part 121, which is provided inside the cabinet 110, supplies the loaded printing medium M using rotation of a first feeding roller 122. The second supply part 125, which is substantially disposed outside of the cabinet 110, supplies the printing medium M to the transferring path 131 using rotation of a second feeding roller 126.

The transferring path 131, which is disposed inside of the cabinet 110 and accommodates transferring of the printing medium M supplied by the supplying unit 120, includes a plurality of transferring rollers 133 and 135. Only the portion of the transferring path 131 for the first and the second supply parts 121 and 125 is divided into two parts, and the portion of the transferring path 131 contributing to the image forming and the discharging paths forms a single path.

The developing unit 160 includes a toner container 161 for accommodating toner T of a predetermined color and an image forming part for contributing to the image forming by being provided with toner T from the toner container 161.

The image forming part includes a photosensitive medium 163 for responding to a beam L scanned from the light scanning unit 170, and a changing unit 165 for charging the photosensitive medium 163 with a predetermined electric potential. A developing roller 167 is disposed opposite the photosensitive medium 163 for developing toner with respect to an area of the photosensitive medium 163 where an electrostatic latent image is formed. A supplying roller 169 supplies toner to the developing roller 167.

The light scanning unit 170 forms an electrostatic latent image on the photosensitive medium 163 by scanning light on the photosensitive medium 163. The light scanning unit includes a light source (refer to the reference numeral 21 in FIG. 2), a beam deflector 30, a housing 40 for enclosing these elements, and a cap member 45 preferably integrally formed with the housing 40 and enclosing the beam deflector 30. By having the cap member 45 integrally formed with the housing 40 as described above, the beam deflector 30 is substantially prevented from being contaminated by substances from the outside and substantially prevents diffused reflection by the beam deflector 30. Here, since the construction of the light scanning unit 170 is substantially similar to the light scanning unit according to exemplary embodiments of the present invention described with reference to FIGS. 2 through 5, a repeat description thereof is omitted.

The transfer unit 173, which is disposed opposite the photosensitive medium 163 with the printing medium M transferred along the transferring path 131 interposed, transfers an image formed on the photosensitive medium 163 to the supplied printing medium M. The image transferred to the printing medium by the transfer unit 173 is fused by the fusing unit 175.

As described above, the light scanning unit and the image forming apparatus adopting the same substantially prevent the beam deflector from being contaminated and shield the beam deflector from stray light to prevent diffused reflection by enclosing the beam deflector in a cap member. Additionally, since the cap member is preferably integrally formed with the housing, the addition of separate parts is not required, thereby reducing production costs and simplifying assembly.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A light scanning unit, comprising:
a light source to generate light;
a beam deflector to deflect and scan the light from the light source in a primary scanning direction of an object;
a housing to enclose the light source and the beam deflector; and
a cap member integrally formed with the housing to enclose the periphery of the beam deflector.

2. The light scanning unit of claim 1, wherein the cap member projects outwardly from an inner surface of the housing and has a space adapted to receiving the beam deflector; and
an opening in part of the cap member allows light from the light source and light scanned from the beam deflector to pass in and out.

3. The light scanning unit of claim 2, wherein
a cover glass is installed in the opening of the cap member to transmit incident light.

4. The light scanning unit of claim 1, wherein the beam deflector has a driving source; and
a polygonal mirror is rotatably installed with respect to the driving source to deflect and scan incident light.

5. The light scanning unit of claim 4, wherein
the cap member projects outwardly from an inner surface of the housing and has a space adapted to receive the beam deflector; and
an opening in part of the cap member allows light from the light source and light scanned from the beam deflector to pass in and out.

6. The light scanning unit of claim 5, wherein
a cover glass is installed in the opening of the cap member to transmit incident light.

7. The light scanning unit of claim 1, wherein
an f-θ lens focuses light onto the object by correcting the light deflected from the beam deflector with different magnifications with respect to a primary and a secondary scanning direction.

8. The light scanning unit of claim 7, wherein
a cap member projects outwardly from an inner surface of the housing and has a space adapted to receive the beam deflector; and
an opening in part of the cap member allows light from the light source and light scanned from the beam deflector to pass in and out.

9. The light scanning unit of claim 8, wherein
a cover glass is installed in the opening of the cap member to transmit incident light.

10. An image forming apparatus, comprising:
a developing unit having a toner container to accommodate toner of a predetermined color and an image forming part adapted to receive toner from the toner container;
a light scanning unit to scan light on the image forming part to form an electrostatic latent image, and having a light source to generate light, a beam deflector to deflect and scan the light from the light source in a primary scanning direction of an object, a housing for enclosing the light source and the beam deflector, and a cap member formed integrally with the housing to enclose the periphery of the beam deflector;
a transfer unit corresponding to the image forming part to transfer an image formed by the image forming part to a printing medium; and
a fusing unit to fuse an image transferred to the printing medium.

11. The image forming apparatus of claim 10, wherein
a cap member projects outwardly from an inner surface of the housing and has a space to receive the beam deflector; and
an opening in part of the cap member allows light from the light source and light scanned from the beam deflector to pass in and out.

12. The image forming apparatus of claim 11, wherein
a cover glass is installed in the opening of the cap member to transmit incident light.

13. The image forming apparatus of claim 10, wherein
the beam deflector has a driving source; and
a polygonal mirror is rotatably installed with respect to the beam deflector to deflect and scan incident light.

14. The image forming apparatus of claim 13, wherein
a cap member projects outwardly from an inner surface of the housing and has a space adapted to receive the beam deflector; and
an opening in part of the cap member allows light from the light source and light scanned from the beam deflector to pass in and out.

15. The image forming apparatus of claim 14, wherein
a cover glass is installed in the opening of the cap member to transmit incident light.

16. The image forming apparatus of claim 10, wherein
an f-θ lens focuses light onto the object by correcting the light deflected from the beam deflector with different magnifications with respect to a primary and a secondary scanning direction.

17. The image forming apparatus of claim 16, wherein
a cap member projects outwardly from an inner surface of the housing and has a space adapted to receive the beam deflector; and
an opening in part of the cap member allows light from the light source and light scanned from the beam deflector to pass in and out.

18. The image forming apparatus of claim 17, wherein
a cover glass is installed in the opening to transmit incident light.

19. A light scanning unit, comprising:
a light source to generate light;
a beam deflector to deflect and scan the light from the light source;
a housing to enclose the light source and the beam deflector;
a cap member connected to the housing to enclose the periphery of the beam deflector; and
an opening in the cap member to allow light from the light source and light scanned from the beam deflector to pass in and out.

20. The light scanning unit of claim 19, wherein
the cap member is integrally formed with the housing.
